(19) United States
(12) Patent Application Publication
(10) Pub. No.: US 2023/0398579 A1
(43) Pub. Date: Dec. 14, 2023

(54) CTV Clutch Cleaning Device

(71) Applicants: James Pamula, Glendale, AZ (US); Christopher Pamula, Peoria, AZ (US)

(72) Inventors: James Pamula, Glendale, AZ (US); Christopher Pamula, Peoria, AZ (US)

(21) Appl. No.: 18/330,081

(22) Filed: Jun. 6, 2023

Related U.S. Application Data
(60) Provisional application No. 63/350,591, filed on Jun. 9, 2022.

(51) Int. Cl. B08B 1/00; B25G 1/04

(52) U.S. Cl. CPC B08B 1/001; B25G 1/04; B60S 3/00

(57) ABSTRACT

A CTV clutch cleaning device is provided. The device is comprised of a body with a second end comprised of an angled cleaning head that receives at least one cleaning pad in a fixedly or removably attached fashion. In one embodiment, the cleaning head is comprised of a pad on each side to allow a user to easily clean the inside of a clutch and/or clutch sheaves within a clutch.

### CROSS-REFERENCE TO RELATED APPLICATION

The present application claims priority to, and the benefit of, U.S. Provisional Application No. 63/350,591, which was filed on Jun. 9, 2022, and is incorporated herein by reference in its entirety.

### FIELD OF THE INVENTION

The present invention relates generally to the field of cleaning devices. More specifically, the present invention relates to a CTV clutch cleaning device comprised of a cleaning head with at least one cleaning pad that can be inserted into a primary/secondary clutch to clean the clutch and clutch sheaves. Accordingly, the present disclosure makes specific reference thereto. Nonetheless, it is to be appreciated that aspects of the present invention are also equally applicable to other like applications, devices, and methods of manufacture.

### BACKGROUND

Cleaning a vehicle clutch is a necessity due to consistent residue building up on the clutches. Said debris can place excessive stress on the belt, causing heat issues and ultimately decreasing the usage life of the belt. When a belt breaks, it will score the clutch sheaves and leave rubber on various surfaces of the sheaves. If the sheaves are not periodically cleaned or cleaned after a belt failure, it can cause the new belt to slip and cause additional problems which are undesirable for vehicle owners. However, cleaning clutches may result in a hand injury, as a user's hand must be placed inside the clutch during cleaning.

Therefore, there exists a long-felt need in the art for a CTV clutch cleaning device. There also exists a long-felt need in the art for a CTV clutch cleaning device that allows a user to clean the sheaves of a clutch. More specifically, there exists a long-felt need in the art for a CTV clutch cleaning device that allows a user to clean the sheaves of a clutch without placing their hand(s) into a clutch.

The subject matter disclosed and claimed herein, in one embodiment thereof, comprises a CTV clutch cleaning device. The device is comprised of a body with a second end comprised of a cleaning head with at least one cleaning pad. The cleaning head receives the pad in a fixedly or removably attached fashion. In one embodiment, the cleaning head is comprised of a pad on each side to allow a user to easily clean the inside of a clutch and/or clutch sheaves within a clutch.

In this manner, the CTV clutch cleaning device of the present invention accomplishes all the foregoing objectives and provides a CTV clutch cleaning device that allows a user to clean the sheaves of a clutch. More specifically, the CTV clutch cleaning device allows a user to clean the sheaves of a clutch in an efficient and safe manner, and without placing their hand(s) into the clutch. In this manner, the CTV clutch cleaning device overcomes the limitations of existing methods of cleaning clutches known in the art.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a CTV clutch cleaning device. The device is primarily comprised of a body with a second end comprised of a cleaning head with at least one cleaning pad. The device is designed to be used to clean a primary and secondary clutch on a vehicle or other piece of motorized equipment/machinery.

The body of the device is comprised of a first end and a second end. The first end is comprised of at least one handle that allows the user to grip the device during use. The second end is comprised of at least one cleaning head with a top surface and a bottom surface. The cleaning head is preferably angled at 45 degrees relative to the body for optimal cleaning.

In one embodiment, at least one cleaning pad attaches to the top surface and at least one cleaning pad attaches to the bottom surface. The cleaning pad may be any type of cleaning or scouring pad known in the art such as, but not limited to, steel wool, polyethylene mesh, etc.

In one embodiment, the pad is fixedly attached to the top surface or removably attached to the top surface via at least one fastener on the top surface and/or pad. This embodiment allows the pad to be easily replaced when dirtied. Similarly, the pad may be fixedly attached to the bottom surface in one embodiment. In a different embodiment, the pad is removably attached to the bottom surface via at least one fastener on the bottom surface and/or pad. This embodiment allows the pad to be easily replaced when dirtied.

The present invention is also comprised of a method of using the device. First, a device is provided comprised of a body comprised of a handle and a cleaning head comprised of at least one cleaning pad. Then, the pad can be placed in a clutch between the clutch sheaves of the clutch and used to clean each sheave. After use, the device can be discarded.

The present invention is also comprised of a second method of using the device. First, a device is provided comprised of a body comprised of a handle and a cleaning head comprised of at least one cleaning pad. Then, a user can attach the pad to the head via at least one fastener on the head. Next, the pad can be placed in a clutch between the clutch sheaves of the clutch and used to clean each sheave. After use, the pad can be removed, discarded, and replaced with a new, clean pad.

Accordingly, the CTV clutch cleaning device of the present invention is particularly advantageous as it provides a CTV clutch cleaning device that allows a user to clean the sheaves of a clutch. More specifically, the CTV clutch cleaning device allows a user to clean the sheaves of a clutch without placing their hand(s) into a clutch. In this manner, the CTV clutch cleaning device overcomes the limitations of existing methods of cleaning clutches known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a CTV clutch cleaning device of the present invention in accordance with the disclosed architecture;

FIG. 2 illustrates a side view of one potential embodiment of a CTV clutch cleaning device of the present invention in accordance with the disclosed architecture;

FIG. 3 illustrates a perspective view of one potential embodiment of a CTV clutch cleaning device of the present invention while being used to clean a clutch in accordance with the disclosed architecture;

FIG. 4 illustrates a flowchart of a method of using one potential embodiment of a CTV clutch cleaning device of the present invention in accordance with the disclosed architecture; and

FIG. 5 illustrates a flowchart of a method of using one potential embodiment of a CTV clutch cleaning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a CTV clutch cleaning device. There also exists a long-felt need in the art for a CTV clutch cleaning device that allows a user to clean the sheaves of a clutch. More specifically, there exists a long-felt need in the art for a CTV clutch cleaning device that allows a user to clean the sheaves of a clutch without placing their hand(s) into a clutch.

The present invention, in one exemplary embodiment, is comprised of a CTV clutch cleaning device primarily comprised of a body with a second end with a cleaning head comprised of at least one cleaning pad. The device is designed to be used to clean a primary and secondary clutch on a vehicle or other piece of motorized equipment/machinery. A first end of the body is comprised of at least one handle that allows the user to grip the device during use. The second end is comprised of at least one cleaning head with a top surface and a bottom surface. The cleaning head is preferably angled at 45 degrees relative to the body for optimal cleaning.

In one embodiment, at least one cleaning pad attaches to the top surface and at least one cleaning pad attaches to the bottom surface. The cleaning pad may be any type of cleaning or scouring pad known in the art such as, but not limited to, steel wool, polyethylene mesh, etc. In one embodiment, the pad is fixedly attached to the top surface or removably attached to the top surface via at least one fastener on the top surface and/or pad. This embodiment allows the pad to be easily replaced when dirtied. Similarly, the pad may be fixedly attached to the bottom surface in one embodiment. In a different embodiment, the pad is removably attached to the bottom surface via at least one fastener on the bottom surface and/or pad. This embodiment allows the pad to be easily replaced when dirtied.

The present invention is also comprised of a method of using the device. First, a device is provided comprised of a body comprised of a handle and a cleaning head comprised of at least one cleaning pad. Then, the pad can be placed in a clutch between the clutch sheaves of the clutch and used to clean each sheave. After use, the device can be discarded.

The present invention is also comprised of a second method of using the device. First, a device is provided comprised of a body comprised of a handle and a cleaning head comprised of at least one cleaning pad. Then, a user can attach the pad to the head via at least one fastener on the head. Next, the pad can be placed in a clutch between the clutch sheaves of the clutch and used to clean each sheave. After use, the pad can be removed; discarded; and replaced with a new, clean pad.

Accordingly, the CTV clutch cleaning device of the present invention is particularly advantageous as it provides a CTV clutch cleaning device that allows a user to clean the sheaves of a clutch. More specifically, the CTV clutch cleaning device allows a user to clean the sheaves of a clutch without placing their hand(s) into a clutch. In this manner, the CTV clutch cleaning device overcomes the limitations of existing methods of cleaning clutches known in the art.

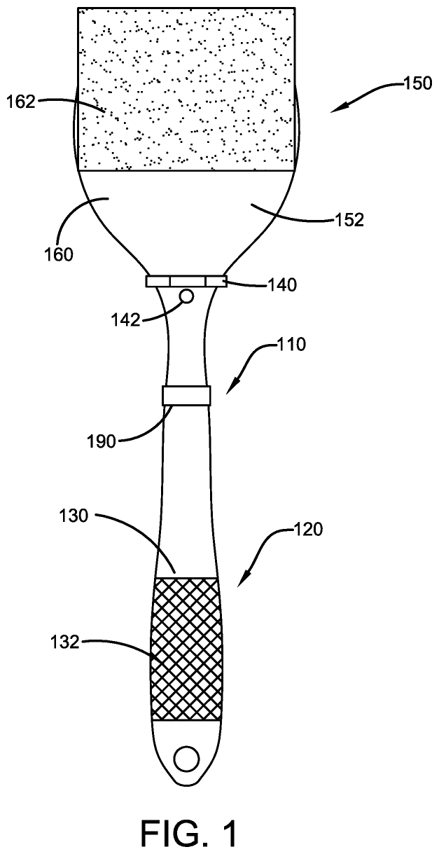

Referring initially to the drawings, FIG. 1 illustrates a top view of one potential embodiment of a CTV clutch cleaning device 100 of the present invention in accordance with the disclosed architecture. The device 100 is primarily comprised of a body 110 with a second end 150 with at least one cleaning pad 162,172. The device 100 is designed to be used to clean a primary and secondary clutch on a vehicle or other piece of motorized equipment/machinery.

The body 110 of the device 100 is comprised of a first end 120 and a second end 150. The body 110 may be made from any material such as, but not limited to, metal, plastic, wood, etc. The body 100 material is preferably 0.25 in thick but may vary in different embodiments. In one embodiment, the body 110 is of a fixed length. In another embodiment, the body 110 is telescopic and therefore adjustable in length. In this embodiment, the length of the body 110 can be locked via at least one locking mechanism 190. The mechanism 190 may be any method known in the art such as, but not limited to, a button, a twisting lock, etc. The first end 120 is comprised of at least one handle 130 that allows the user to grip the device 100 during use. In one embodiment, the handle 130 is comprised of at least one grip area 132. The grip area 132 may be comprised of a non-slip material (such as, but not limited to, rubber) that may be textured (with a raised or recessed texture) or non-textured. The grip area 132 improves grip on the handle 130 during use.

The second end 150 is comprised of at least one cleaning head 152 with a top surface 160 and a bottom surface 170. The cleaning head 152 is preferably angled at 45 degrees relative to the body 110 to achieve the optimal cleaning angle. However, the head 152 may be at any angle relative to the body 110 in different embodiments between 0 and 90 degrees. In one embodiment, the head 152 attaches to the body 110 via at least one hinge 140. The hinge 140 may be any hinge type or otherwise pivoting/rotating member known in the art. The angle of the hinge 140 may be locked via at least one button 142 or other similar locking mechanism known in the art.

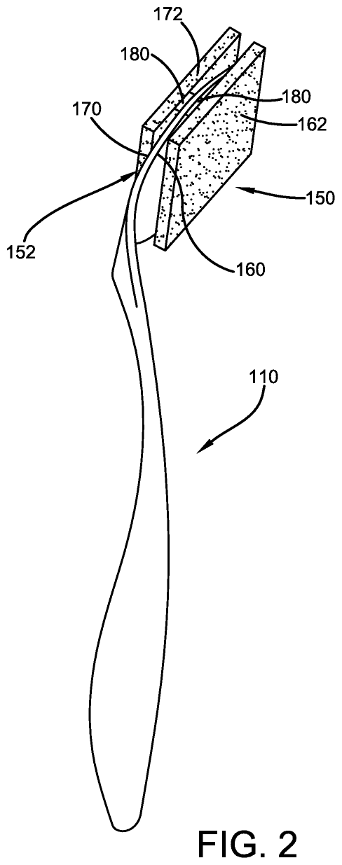

In one embodiment, at least one cleaning pad 162 attaches to the top surface 160 and at least one cleaning pad 172 attaches to the bottom surface 170, as seen in FIG. 2. The cleaning pad 162,172 may be any type of cleaning or scouring pad known in the art such as, but not limited to, steel wool, polyethylene mesh, etc.

In one embodiment, the pad 162 is fixedly attached to the top surface 160. In a different embodiment, the pad 162 is removably attached to the top surface 160 via at least one fastener 180 on the top surface 160 and/or pad 162. The fastener 180 may be any type known in the art such as, but not limited to, hook, loop, magnet, adhesive, snap button, tongue, groove, etc. This embodiment allows the pad 162 to be easily replaced when dirtied.

In one embodiment, the pad 172 is fixedly attached to the bottom surface 170. In a different embodiment, the pad 172 is removably attached to the bottom surface 170 via at least one fastener 180 on the bottom surface 170 and/or pad 172. The fastener 180 may be any type known in the art such as, but not limited to, hook, loop, magnet, adhesive, snap button, tongue, groove, etc. This embodiment allows the pad 172 to be easily replaced when dirtied.

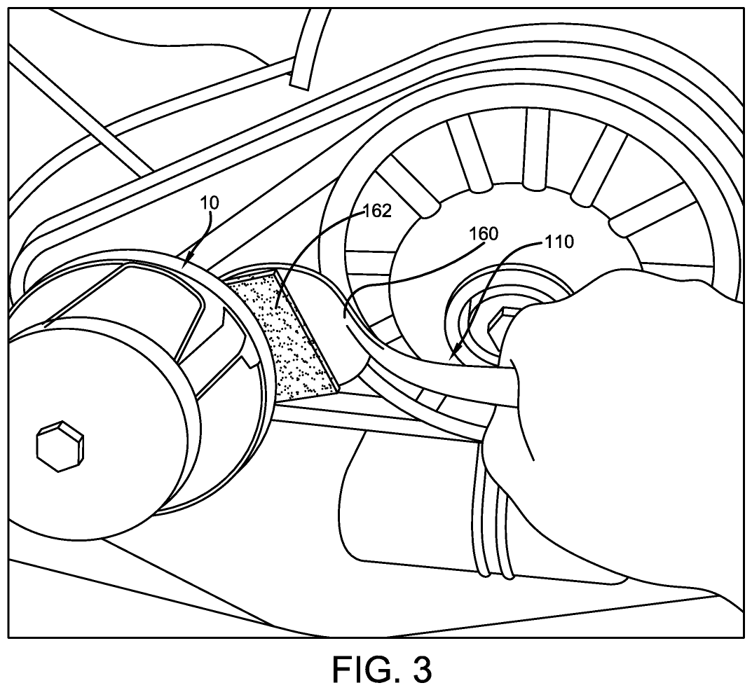

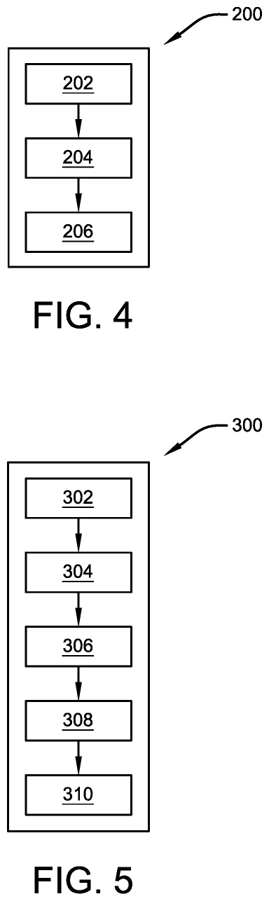

The present invention is also comprised of a method of using 200 the device 100, as seen in FIG. 4. First, a device 100 is provided comprised of a body 110 comprised of a handle 130 and a cleaning head 152 comprised of at least one cleaning pad 162,172 [Step 202]. Then, the pad 162 can be placed in a clutch 10 between the clutch sheaves of the clutch 10 and used to clean each sheave, as seen in FIG. 3 [Step 204]. After use, the device 100 can be discarded [Step 206].

The present invention is also comprised of a second method of using 300 the device 100, as seen in FIG. 5. First, a device 100 is provided comprised of a body 110 comprised of a handle 130 and a cleaning head 152 comprised of at least one cleaning pad 162,172 [Step 302]. Then, a user can attach the pad 162,172 to the head 152 via at least one fastener 180 on the head 152 [Step 304]. Next, the telescopic body 110 can be adjusted and locked at a desired length via the locking mechanism 190 [Step 306]. Then, the head 152 and pad 162 can be positioned in a clutch 10 between the clutch sheaves of the clutch 10 such that the pad 162 is used to clean each sheave, as seen in FIG. 3 [Step 308]. After use, the pad 162,172 can be removed; discarded; and replaced with a new, clean pad 162,172 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “CTV clutch cleaning device” and “device” are interchangeable and refer to the CTV clutch cleaning device 100 of the present invention.

Notwithstanding the foregoing, the CTV clutch cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the CTV clutch cleaning device 100 as shown in the FIGS. are for illustrative purposes only, and that many other sizes and shapes of the CTV clutch cleaning device 100 are well within the scope of the present disclosure. Although the dimensions of the CTV clutch cleaning device 100 are important design parameters for user convenience, the CTV clutch cleaning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A CTV clutch cleaning device comprising:
a body comprised of a first end and a second end;
a handle positioned on the first end;
a cleaning head positioned on the second end; and
a pad attached to the cleaning head.

2. The CTV clutch cleaning device of claim 1, wherein the body is comprised of a telescopic body.

3. The CTV clutch cleaning device of claim 2, wherein the telescopic body is comprised of a locking mechanism that locks the telescopic body at a length.

4. The CTV clutch cleaning device of claim 1, wherein the handle is comprised of a grip area.

5. The CTV clutch cleaning device of claim 4, wherein the grip area is comprised of a raised or a recessed texture.

6. The CTV clutch cleaning device of claim 4, wherein the grip area is comprised of a non-slip rubber material.

7. The CTV clutch cleaning device of claim 1, wherein the cleaning head forms a 45-degree angle with the body.

8. A CTV clutch cleaning device comprising:
a body comprised of a first end and a second end;
a handle positioned on the first end, the handle comprised of a grip area;
a cleaning head positioned on the second end;
a first pad attached to a top surface of the cleaning head; and
a second pad attached to a second surface of the cleaning head.

9. The CTV clutch cleaning device of claim 8, wherein the cleaning head attaches to the body via a hinge.

10. The CTV clutch cleaning device of claim 8, wherein the cleaning head forms an angle relative to the body between 0 and 360 degrees.

11. The CTV clutch cleaning device of claim 8, wherein the first pad is comprised of a first fastener.

12. The CTV clutch cleaning device of claim 11, wherein the first fastener is comprised of a hook fastener, a loop fastener, a magnet fastener, an adhesive fastener, a snap button fastener, a tongue fastener, or a groove fastener.

13. The CTV clutch cleaning device of claim 8, wherein the second pad is comprised of a second fastener.

14. The CTV clutch cleaning device of claim 13, wherein the second fastener is comprised of a hook fastener, a loop fastener, a magnet fastener, an adhesive fastener, a snap button fastener, a tongue fastener, or a groove fastener.

15. The CTV clutch cleaning device of claim 8, wherein the first pad is comprised of a cleaning pad.

16. The CTV clutch cleaning device of claim 15, wherein the cleaning pad is comprised of a steel wool or a polyethylene mesh.

17. The CTV clutch cleaning device of claim 8, wherein the second pad is comprised of a cleaning pad.

18. The CTV clutch cleaning device of claim 17, wherein the cleaning pad is comprised of a steel wool or a polyethylene mesh.

19. A method of using a CTV clutch cleaning device, the method comprising the following steps:
providing a CTV clutch cleaning device comprised of a body comprised of a handle and a cleaning head comprised of a cleaning pad;
positioning the cleaning head and the cleaning pad clutch between a first clutch sheave and a second clutch sheave of a clutch; and
cleaning the first clutch sheave and the second clutch sheave using the cleaning pad.

20. The method of claim 19 comprised of a step of removing the cleaning pad from the cleaning head after cleaning the first clutch sheave and the second clutch sheave and an additional step of replacing a second cleaning pad onto the cleaning head.
